(19) United States
(12) Patent Application Publication
(10) Pub. No.: US 2026/0086872 A1
(43) Pub. Date: Mar. 26, 2026

(54) DISTRIBUTED TASK LOAD BALANCING SCHEDULING METHOD AND SYSTEM

(71) Applicant: Huaneng Information Technology Co., Ltd., Qingdao City (CN)

(72) Inventors: Yong XIAO, Qingdao City (CN); Shuo HAN, Qingdao City (CN); Sheng YE, Qingdao City (CN); Hao GUO, Qingdao City (CN); Wenwei LIU, Qingdao City (CN); Cheng FAN, Qingdao City (CN); Yubao ZHOU, Qingdao City (CN); Shouhui XIN, Qingdao City (CN); Huanxiu DING, Qingdao City (CN); Wei LI, Qingdao City (CN)

(73) Assignee: Huaneng Information Technology Co., Ltd., Qingdao City (CN)

(21) Appl. No.: 19/356,099

(22) Filed: Oct. 11, 2025

(30) Foreign Application Priority Data
Jun. 23, 2025 (CN) 202510837231.6

(51) Int. Cl. G06F 9/50; G06F 11/34; G06F 18/2413

(52) U.S. Cl. CPC G06F 9/505; G06F 9/5083; G06F 11/3433; G06F 18/24137

(57) ABSTRACT

Provided are a distributed task load balancing scheduling method and system. The method includes: acquiring performance requirement indicators of tasks to be executed, and allocating the tasks to be executed to server nodes in a server cluster network topology according to the performance requirement indicators; acquiring historical load change rates of the server nodes, and determining a load threshold corresponding to each server node according to the historical load change rates; and acquiring real-time performance indicators of the server nodes, determining load score values according to the real-time performance indicators of the server nodes, screening out overloaded server nodes whose load score values exceed the load thresholds, and performing load balancing scheduling on tasks in the overloaded server nodes. The present disclosure can accurately calculate the optimal allocation node for each task, provide a refined task scheduling strategy for a server cluster network, and effectively improve the load balancing degree.

### CROSS-REFERENCE TO RELATED APPLICATIONS

This application claims priority of Chinese Patent Application No. 202510837231.6, filed on Jun. 23, 2025, the contents of which are hereby incorporated by reference.

### TECHNICAL FIELD

This application relates to the field of load balancing technologies, and more particularly, to a distributed task load balancing scheduling method and system.

### BACKGROUND

Cloud platforms are constructed in different application forms, and digital resources are stored in service platforms. Resource users can access cloud platforms to efficiently apply cloud service platforms and acquire relevant resources without time and location restrictions. Load balancing of cloud platform server nodes refers to reasonably distributing network requests or computing tasks to multiple server nodes through specific technologies and strategies to ensure balanced resource allocation and improve system performance, reliability, and scalability.

However, due to the high dynamics and heterogeneity of cloud platform environments and the different resource requirements of different tasks for server nodes, existing technologies cannot meet the diverse needs of tasks in the load balancing scheduling process of server nodes, resulting in unreasonable task allocation and low scheduling efficiency.

### SUMMARY

The present disclosure provides a distributed task load balancing scheduling method and system to solve the problems of unreasonable task allocation and low scheduling efficiency in load balancing scheduling of server nodes in the prior art. The method includes: acquiring performance requirement indicators of tasks to be executed, and allocating the tasks to be executed to server nodes in a server cluster network topology according to the performance requirement indicators of the tasks to be executed; acquiring historical load change rates of the server nodes, and determining a load threshold corresponding to each server node according to the historical load change rates of the server nodes; and acquiring real-time performance indicators of the server nodes, determining load score values according to the real-time performance indicators of the server nodes, screening out overloaded server nodes whose load score values exceed the load thresholds, and performing load balancing scheduling on tasks in the overloaded server nodes.

Further, said allocating the tasks to be executed to server nodes in a server cluster network topology according to the performance requirement indicators of the tasks to be executed includes: acquiring the performance requirement indicators of each task to be executed, the performance requirement indicators including a CPU requirement indicator, an IO requirement indicator, a network requirement indicator, and a memory requirement indicator; establishing a center of a circle, and taking the center of the circle as a starting point to evenly draw rays to the surroundings as indicator axes; normalizing the performance requirement indicators of the task to be executed, and filling the normalized performance requirement indicators into the indicator axes; and connecting the normalized performance requirement indicators on the indicator axes in sequence to obtain a performance requirement indicator radar chart of the task to be executed, and allocating the task to be executed to one server node according to the performance requirement indicator radar chart of the task to be executed.

Further, said allocating the task to be executed to one server node according to the performance requirement indicator radar chart of the task to be executed includes: acquiring node performance indicators of each of current server nodes, the node performance indicators including a CPU resource indicator, an IO resource indicator, a network resource indicator, and a memory resource indicator; establishing a node resource indicator radar chart according to the node performance indicators, and calculating a matching degree between the node resource indicator radar chart of each server node and the performance requirement indicator radar chart of the task to be executed; and allocating the task to be executed to the server node according to the matching degree between the node resource indicator radar chart of each server node and the performance requirement indicator radar chart of the task to be executed.

Further, said calculating a matching degree between the node resource indicator radar chart of each server node and the performance requirement indicator radar chart of the task to be executed includes: superimposing a center point of the node resource indicator radar chart and a center point of the performance requirement indicator radar chart of the task to be executed, and aligning vertices of the two radar charts to obtain a superimposed chart of the node resource indicator radar chart and the performance requirement indicator radar chart; calculating absolute distance differences between corresponding vertices of the node resource indicator radar chart and the performance requirement indicator radar chart in the superimposed chart, and determining an average absolute distance difference according to all the absolute distance differences between the vertices in the superimposed chart; calculating cosine values of included angles between corresponding edges of the node resource indicator radar chart and the performance requirement indicator radar chart in the superimposed chart, and determining an average cosine value according to the cosine values of all the included angles in the superimposed chart; and multiplying the average absolute distance difference by the average cosine value to obtain the matching degree between the node resource indicator radar chart and the performance requirement indicator radar chart of the task to be executed.

Further, said determining a load threshold corresponding to each server node according to the historical load change rates of the server nodes includes: clustering each server node according to the historical load change rates of the server nodes, acquiring preset load thresholds of the server nodes, and determining a cluster center of a cluster corresponding to each server node according to a clustering result; and correcting the preset load thresholds according to the cluster center of the cluster corresponding to each server node to obtain corrected load thresholds.

Further, said clustering each server node according to the historical load change rates of the server nodes includes: establishing a sample dataset according to the historical load change rates of all the server nodes, and randomly selecting k initial cluster centers from the sample dataset; calculating Manhattan distances from sample data in the sample dataset to each of the initial cluster centers, and dividing each server node into a corresponding cluster according to the Manhattan distances from the sample data in the sample dataset to each of the initial cluster centers; calculating an average value of the sample data in each cluster, and recalculating the cluster center according to the average value of the sample data in each cluster; and iteratively repeating above steps until the cluster center no longer change or a number of iterations reaches a preset maximum number of iterations to obtain the clustering result of the server nodes.

Further, said determining load score values according to the real-time performance indicators of the server nodes comprises: acquiring real-time performance indicators of each server node in a historical server cluster network topology, the real-time performance indicators including a CPU operation indicator, an IO occupancy indicator, a network operation indicator, and a memory occupancy indicator, and establishing a training sample set according to the real-time performance indicators of each server node in the historical server cluster network topology; performing expert manual scoring on the real-time performance indicators in the training sample set to obtain manually labeled load score encodings; establishing a deep neural network model to perform load score encoding on the real-time performance indicators in the training sample set, and calculating a loss value between the load score encoding output by the deep neural network and the manually labeled load score encoding; iteratively training parameters of the deep neural network by minimizing the loss value to obtain a deep neural network model capable of encoding the real-time performance indicators of the server nodes into corresponding load score values; and inputting the real-time performance indicators of the current server nodes into the trained deep neural network model to obtain the corresponding load score values.

Further, said performing load balancing scheduling on tasks in the overloaded server nodes comprises: detecting surrounding nodes of each overloaded server node in the server cluster network topology, and calculating a replacement matching degree between each surrounding node and each task to be offloaded; and transferring, when the replacement matching degree between the surrounding node and the task to be offloaded is greater than a first preset threshold, the task to be offloaded to a corresponding surrounding node.

Further, said calculating a replacement matching degree between each surrounding node and each task to be offloaded includes: calculating the replacement matching degree between each surrounding node and each task to be offloaded according to a replacement matching degree calculation formula, the replacement matching degree calculation formula being:

$$C = \frac{{R}_{i}}{{R}_{α i}} ln ( 1 + \frac{1}{{d}_{i} + 1} ) * exp ( \frac{{P}_{i} - {P}_{α}}{N} ) ,$$

where C is the replacement matching degree, Rᵢ is a node load value of an i-th surrounding node, R_{αi} is a corrected load threshold of the i-th surrounding node, dᵢ is a network distance value between the i-th surrounding node and the overloaded server node, Pᵢ is the matching degree between the node resource indicator radar chart of the i-th surrounding node and the performance requirement indicator radar chart of the task to be offloaded, P_{α} is a preset standard matching degree, and N is a range adjustment coefficient.

To achieve the above objective, the present disclosure further provides a distributed task load balancing scheduling system, including: a task module configured to acquire performance requirement indicators of tasks to be executed, and allocate the tasks to be executed to server nodes in a server cluster network topology according to the performance requirement indicators of the tasks to be executed; a threshold module configured to acquire historical load change rates of the server nodes, and determining a load threshold corresponding to each server node according to the historical load change rates of the server nodes; and a scheduling module configured to acquire real-time performance indicators of the server nodes, determine load score values according to the real-time performance indicators of the server nodes, screen out overloaded server nodes whose load score values exceed the load thresholds, and performing load balancing scheduling on tasks in the overloaded server nodes.

Advantageous effects of the present disclosure lie in that:
by applying the above technical solutions, the present disclosure can allocate correspondingly adapted server nodes for the tasks to be executed with different performance requirements, accurately calculate the optimal allocation node for each task, simultaneously monitor performance indicators of each server node in real time, timely detect overloaded server nodes and allocate overloaded tasks therein to optimally adapted nodes in the server cluster network topology, provide a refined task scheduling strategy for a server cluster network, and effectively improve load balancing.

### BRIEF DESCRIPTION OF THE DRAWINGS

To clearly illustrate the technical solutions in the embodiments of the present application, the drawings required to be used in the description of the embodiments will be briefly introduced below. Obviously, the drawings in the following description are only some embodiments of the present application. For those of ordinary skill in the art, other drawings can be obtained according to these drawings without creative efforts.

FIG. 1 shows an overall flowchart of a distributed task load balancing scheduling method proposed by an embodiment of the present disclosure;

FIG. 2 shows a structural schematic diagram of a distributed task load balancing scheduling system proposed by an embodiment of the present disclosure.

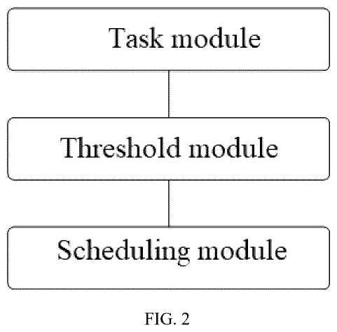

### DETAILED DESCRIPTION OF THE EMBODIMENTS

The technical solutions in the embodiments of the present application will be clearly and completely described in conjunction with the drawings in the embodiments of the present application. Obviously, the described embodiments are only part of the embodiments of the present application, not all of them. Based on the embodiments in the present application, all other embodiments obtained by those of ordinary skill in the art without creative efforts belong to the protection scope of the present application.

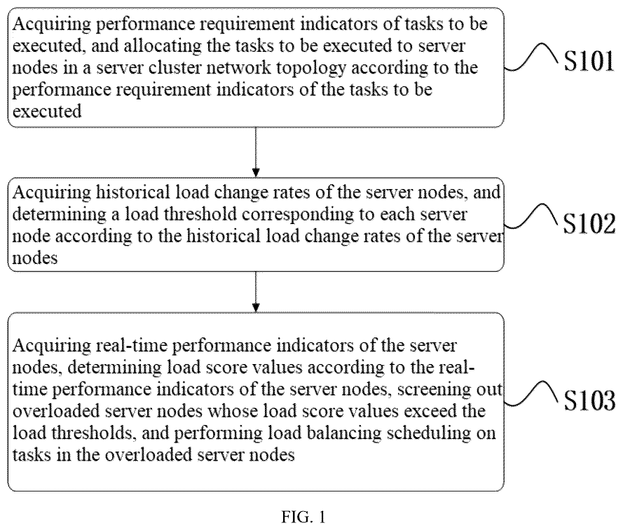

An embodiment of the present application provides a distributed task load balancing scheduling method, as shown in FIG. 1, including S101-S103.

S101: acquiring performance requirement indicators of tasks to be executed, and allocating the tasks to be executed to server nodes in a server cluster network topology according to the performance requirement indicators of the tasks to be executed.

In some embodiments of the present application, said allocating the tasks to be executed to server nodes in a server cluster network topology according to the performance requirement indicators of the tasks to be executed comprises: acquiring the performance requirement indicators of each task to be executed, the performance requirement indicators including a CPU requirement indicator, an IO requirement indicator, a network requirement indicator, and a memory requirement indicator; establishing a center of a circle, and taking the center of the circle as a starting point to evenly draw rays to the surroundings as indicator axes; normalizing the performance requirement indicators of the task to be executed, and filling the normalized performance requirement indicators into the indicator axes; and connecting the normalized performance requirement indicators on the indicator axes in sequence to obtain a performance requirement indicator radar chart of the task to be executed, and allocating the task to be executed to one server node according to the performance requirement indicator radar chart of the task to be executed.

In this embodiment, by detecting the CPU requirement indicator, the IO requirement indicator, the network requirement indicator, and the memory requirement indicators of the task to be executed, and integrating the above-mentioned four indicators into the performance requirement indicator radar chart, the multi-dimensional requirements of the task to be executed is comprehensively reflected, so that correspondingly adapted server nodes can be allocated through the performance requirement indicator radar chart.

In some embodiments of the present application, said allocating the task to be executed to one server node according to the performance requirement indicator radar chart of the task to be executed comprises: acquiring node performance indicators of each of current server nodes, the node performance indicators including a CPU resource indicator, an IO resource indicator, a network resource indicator, and a memory resource indicator; establishing a node resource indicator radar chart according to the node performance indicators, and calculating a matching degree between the node resource indicator radar chart of each server node and the performance requirement indicator radar chart of the task to be executed; and allocating the task to be executed to the server node according to the matching degree between the node resource indicator radar chart of each server node and the performance requirement indicator radar chart of the task to be executed.

In this embodiment, the node performance indicators of each server node are detected in turn, and the node performance indicators are integrated into the node resource indicator radar chart, so as to calculate the matching degree between the node resource indicator radar chart of each server node and the performance requirement indicator radar chart, and allocate the task to be executed to the server node according to the matching degree.

In some embodiments of the present application, said calculating a matching degree between the node resource indicator radar chart of each server node and the performance requirement indicator radar chart of the task to be executed comprises: superimposing a center point of the node resource indicator radar chart and a center point of the performance requirement indicator radar chart of the task to be executed, and aligning vertices of the two radar charts to obtain a superimposed chart of the node resource indicator radar chart and the performance requirement indicator radar chart; calculating absolute distance differences between corresponding vertices of the node resource indicator radar chart and the performance requirement indicator radar chart in the superimposed chart, and determining an average absolute distance difference according to all the absolute distance differences between the vertices in the superimposed chart; calculating cosine values of included angles between corresponding edges of the node resource indicator radar chart and the performance requirement indicator radar chart in the superimposed chart, and determining an average cosine value according to the cosine values of all the included angles in the superimposed chart; and multiplying the average absolute distance difference by the average cosine value to obtain the matching degree between the node resource indicator radar chart and the performance requirement indicator radar chart of the task to be executed.

In this embodiment, the center points of the two radar charts are superimposed, and the vertices of each indicator are aligned according to the CPU requirement indicator-the CPU resource indicator, the IO requirement indicator-the IO resource indicator, the network requirement indicator-the network resource indicator, and the memory requirement indicator-the memory resource indicator to obtain the superimposed chart; an edge connecting two adjacent vertices of the node resource indicator radar chart and an edge connecting corresponding vertices of the performance requirement indicator radar chart in the superimposed chart are extracted; the cosine value of the acute angle included between the two edges is calculated to obtain the cosine value of the included angle; the average cosine value of the cosine values of all the included angles in the superimposed chart is calculated; through the average cosine value, the resource deviation between node resources and the resource requirements of the task to be executed is calculated more accurately; and at the same time, combined with the average absolute distance difference, the matching degree between the node resource indicator radar chart and the performance requirement indicator radar chart of the task to be executed is calculated.

S102: acquiring historical load change rates of the server nodes, and determining a load threshold corresponding to each server node according to the historical load change rates of the server nodes.

In some embodiments of the present application, said determining a load threshold corresponding to each server node according to the historical load change rates of the server nodes comprises: clustering each server node according to the historical load change rates of the server nodes, acquiring preset load thresholds of the server nodes, and determining a cluster center of a cluster corresponding to each server node according to a clustering result; and correcting the preset load thresholds according to the cluster center of the cluster corresponding to each server node to obtain corrected load thresholds.

Said clustering each server node according to the historical load change rates of the server nodes includes: establishing a sample dataset according to the historical load change rates of all the server nodes, and randomly selecting k initial cluster centers from the sample dataset; calculating Manhattan distances from sample data in the sample dataset to each of the initial cluster centers, and dividing each server node into a corresponding cluster according to the Manhattan distances from the sample data in the sample dataset to each of the initial cluster centers; calculating an average value of the sample data in each cluster, and recalculating the cluster center according to the average value of the sample data in each cluster; and iteratively repeating above steps until the cluster center no longer change or a number of iterations reaches a preset maximum number of iterations to obtain the clustering result of the server nodes.

In this embodiment, each server node is artificially set with a preset load threshold; each server node is clustered based on a k-means clustering algorithm through the historical load change rates of the server nodes; the cluster center of the cluster corresponding to each server node is extracted; each cluster center is subjected to per-unit processing, and its value is limited to [0.5-1.5]; the cluster center after per-unit processing is set as a correction coefficient; the correction coefficient is multiplied by the preset load threshold of the server node to obtain the corrected load threshold.

S103: acquiring real-time performance indicators of the server nodes, determining load score values according to the real-time performance indicators of the server nodes, screening out overloaded server nodes whose load score values exceed the load thresholds, and performing load balancing scheduling on tasks in the overloaded server nodes.

In some embodiments of the present application, said determining load score values according to the real-time performance indicators of the server nodes includes: acquiring real-time performance indicators of each server node in a historical server cluster network topology, the real-time performance indicators including a CPU operation indicator, an IO occupancy indicator, a network operation indicator, and a memory occupancy indicator, and establishing a training sample set according to the real-time performance indicators of each server node in the historical server cluster network topology; performing expert manual scoring on the real-time performance indicators in the training sample set to obtain manually labeled load score encodings; establishing a deep neural network model to perform load score encoding on the real-time performance indicators in the training sample set, and calculating a loss value between the load score encoding output by the deep neural network and the manually labeled load score encoding; iteratively training parameters of the deep neural network by minimizing the loss value to obtain a deep neural network model capable of encoding the real-time performance indicators of the server nodes into corresponding load score values; and inputting the real-time performance indicators of the current server nodes into the trained deep neural network model to obtain the corresponding load score values.

In this embodiment, historical operation records of a cloud platform are collected to obtain real-time performance indicators of each server node in the historical server cluster network topology; vectorization processing is performed on the real-time performance indicators to obtain the training sample set; the deep neural network model is established to perform load score encoding on the vectorized real-time performance indicators; the loss value between the load score encoding output by the network and the load score encoding manually labeled by actual computer experts is calculated; the parameters of the deep neural network are iteratively trained by minimizing the loss value, so as to obtain the trained deep neural network model and output load score values corresponding to the current server nodes.

In some embodiments of the present application, said performing load balancing scheduling on tasks in the overloaded server nodes comprises: detecting surrounding nodes of each overloaded server node in the server cluster network topology, and calculating a replacement matching degree between each surrounding node and each task to be offloaded; and transferring, when the replacement matching degree between the surrounding node and the task to be offloaded is greater than a first preset threshold, the task to be offloaded to a corresponding surrounding node.

In this embodiment, after detecting the overloaded server nodes, a task with a highest load occupancy rate is extracted as the task to be offloaded.

In some embodiments of the present application, said calculating a replacement matching degree between each surrounding node and each task to be offloaded comprises: calculating the replacement matching degree between each surrounding node and each task to be offloaded according to a replacement matching degree calculation formula, the replacement matching degree calculation formula being:

$$C = \frac{{R}_{i}}{{R}_{α i}} ln ( 1 + \frac{1}{{d}_{i} + 1} ) * exp ( \frac{{P}_{i} - {P}_{α}}{N} ) ,$$

where C is the replacement matching degree, Rᵢ is a node load value of an i-th surrounding node, R_{αi} is a corrected load threshold of the i-th surrounding node, dᵢ is a network distance value between the i-th surrounding node and the overloaded server node, Pᵢ is the matching degree between the node resource indicator radar chart of the i-th surrounding node and the performance requirement indicator radar chart of the task to be offloaded, P_{α} is a preset standard matching degree, N is a range adjustment coefficient, and exp is a natural exponential function.

In this embodiment, first, nodes within a first preset range of a server node are taken as surrounding nodes; a node load utilization rate of the surrounding node corresponding to the overloaded server node is obtained through

$$\frac{{R}_{i}}{{R}_{α i}} ;$$

a distance influence coefficient between the overloaded server node and the surrounding node is obtained through

$$ln ( 1 + \frac{1}{{d}_{i} + 1} ) ,$$

and the smaller the network distance, the higher this value; the matching degree between the surrounding node and the task to be offloaded is calculated through

$$exp ( \frac{{P}_{i} - {P}_{α}}{N} ) ;$$

whether the surrounding node can accept the scheduling of the overloaded server node is comprehensively determined by combining the above-mentioned parameters; if there is no surrounding node meeting the condition, the range of the surrounding node is expanded successively until there appear a surrounding node meeting the condition, so as to realize load balancing of a server cluster network.

To achieve the above objective, the present disclosure further provides a distributed task load balancing scheduling system, including: a task module configured to acquire performance requirement indicators of tasks to be executed, and allocate the tasks to be executed to server nodes in a server cluster network topology according to the performance requirement indicators of the tasks to be executed; a threshold module configured to acquire historical load change rates of the server nodes, and determining a load threshold corresponding to each server node according to the historical load change rates of the server nodes; and a scheduling module configured to acquire real-time performance indicators of the server nodes, determine load score values according to the real-time performance indicators of the server nodes, screen out overloaded server nodes whose load score values exceed the load thresholds, and performing load balancing scheduling on tasks in the overloaded server nodes.

By applying the above technical solutions, the present disclosure: allocates the tasks to be executed to the server nodes in the server cluster network topology by acquiring the performance requirement indicators of the tasks to be executed and according to the performance requirement indicators of the tasks to be executed; acquires the historical load change rates of the server nodes, and determines the load threshold corresponding to each server node according to the historical load change rates of the server nodes; and acquires the real-time performance indicators of the server nodes, determines the load score values according to the real-time performance indicators of the server nodes, screens out the overloaded server nodes whose load score values exceed the load thresholds, and performs load balancing scheduling on tasks in the overloaded server nodes. The present disclosure can accurately calculate the optimal allocation node for each task, provide a refined task scheduling strategy for the server cluster network, and effectively improve the load balancing degree.

From the description of the above embodiments, those of ordinary skill in the art can clearly understand that the present disclosure can be implemented by hardware, or by software plus a necessary universal hardware platform. Based on such understanding, the technical solutions of the present disclosure can be embodied in the form of a software product, which can be stored in a non-volatile storage medium (which can be a CD-ROM, a U disk, a mobile hard disk, etc.), and includes several instructions to enable a computer device (which can be a personal computer, a server, or a network device, etc.) to execute the method described in each implementation scenario of the present disclosure.

Finally, it should be noted that the above embodiments are only used to illustrate the technical solutions of the present application, but not to limit them; and although the present application has been described in detail with reference to the foregoing embodiments, those of ordinary skill in the art should understand that they can still modify the technical solutions described in the foregoing embodiments, or replace some technical features therein with equivalents; and these modifications or replacements do not make the essence of the corresponding technical solutions deviate from the spirit and scope of the technical solutions of the embodiments of the present application.

What is claimed is:

1. A distributed task load balancing scheduling method, comprising:
acquiring performance requirement indicators of tasks to be executed, and allocating the tasks to be executed to server nodes in a server cluster network topology according to the performance requirement indicators of the tasks to be executed;
acquiring historical load change rates of the server nodes, and determining a load threshold corresponding to each server node according to the historical load change rates of the server nodes; and
acquiring real-time performance indicators of the server nodes, determining load score values according to the real-time performance indicators of the server nodes, screening out overloaded server nodes whose load score values exceed the load thresholds, and performing load balancing scheduling on tasks in the overloaded server nodes;
wherein said allocating the tasks to be executed to server nodes in a server cluster network topology according to the performance requirement indicators of the tasks to be executed comprises:
acquiring the performance requirement indicators of each task to be executed, the performance requirement indicators including a CPU requirement indicator, an IO requirement indicator, a network requirement indicator, and a memory requirement indicator;
establishing a center of a circle, and taking the center of the circle as a starting point to evenly draw rays to the surroundings as indicator axes;
normalizing the performance requirement indicators of the task to be executed, and filling the normalized performance requirement indicators into the indicator axes; and
connecting the normalized performance requirement indicators on the indicator axes in sequence to obtain a performance requirement indicator radar chart of the task to be executed, and allocating the task to be executed to one server node according to the performance requirement indicator radar chart of the task to be executed.

2. The distributed task load balancing scheduling method according to claim 1, wherein said allocating the task to be executed to one server node according to the performance requirement indicator radar chart of the task to be executed comprises:
acquiring node performance indicators of each of current server nodes, the node performance indicators including a CPU resource indicator, an IO resource indicator, a network resource indicator, and a memory resource indicator;
establishing a node resource indicator radar chart according to the node performance indicators, and calculating a matching degree between the node resource indicator radar chart of each server node and the performance requirement indicator radar chart of the task to be executed; and
allocating the task to be executed to the server node according to the matching degree between the node resource indicator radar chart of each server node and the performance requirement indicator radar chart of the task to be executed.

3. The distributed task load balancing scheduling method according to claim 2, wherein said calculating a matching degree between the node resource indicator radar chart of each server node and the performance requirement indicator radar chart of the task to be executed comprises:
superimposing a center point of the node resource indicator radar chart and a center point of the performance requirement indicator radar chart of the task to be executed, and aligning vertices of the two radar charts to obtain a superimposed chart of the node resource indicator radar chart and the performance requirement indicator radar chart;
calculating absolute distance differences between corresponding vertices of the node resource indicator radar chart and the performance requirement indicator radar chart in the superimposed chart, and determining an average absolute distance difference according to all the absolute distance differences between the vertices in the superimposed chart;
calculating cosine values of included angles between corresponding edges of the node resource indicator radar chart and the performance requirement indicator radar chart in the superimposed chart, and determining an average cosine value according to the cosine values of all the included angles in the superimposed chart; and
multiplying the average absolute distance difference by the average cosine value to obtain the matching degree between the node resource indicator radar chart and the performance requirement indicator radar chart of the task to be executed.

4. The distributed task load balancing scheduling method according to claim 3, wherein said determining a load threshold corresponding to each server node according to the historical load change rates of the server nodes comprises:
clustering each server node according to the historical load change rates of the server nodes, acquiring preset load thresholds of the server nodes, and determining a cluster center of a cluster corresponding to each server node according to a clustering result; and
correcting the preset load thresholds according to the cluster center of the cluster corresponding to each server node to obtain corrected load thresholds.

5. The distributed task load balancing scheduling method according to claim 4, wherein said clustering each server node according to the historical load change rates of the server nodes comprises:
establishing a sample dataset according to the historical load change rates of all the server nodes, and randomly selecting k initial cluster centers from the sample dataset;
calculating Manhattan distances from sample data in the sample dataset to each of the initial cluster centers, and dividing each server node into a corresponding cluster according to the Manhattan distances from the sample data in the sample dataset to each of the initial cluster centers;
calculating an average value of the sample data in each cluster, and recalculating the cluster center according to the average value of the sample data in each cluster; and
iteratively repeating above steps until the cluster center no longer change or a number of iterations reaches a preset maximum number of iterations to obtain the clustering result of the server nodes.

6. The distributed task load balancing scheduling method according to claim 1, wherein said determining load score values according to the real-time performance indicators of the server nodes comprises:
acquiring real-time performance indicators of each server node in a historical server cluster network topology, the real-time performance indicators including a CPU operation indicator, an IO occupancy indicator, a network operation indicator, and a memory occupancy indicator, and establishing a training sample set according to the real-time performance indicators of each server node in the historical server cluster network topology;
performing expert manual scoring on the real-time performance indicators in the training sample set to obtain manually labeled load score encodings;
establishing a deep neural network model to perform load score encoding on the real-time performance indicators in the training sample set, and calculating a loss value between the load score encoding output by the deep neural network and the manually labeled load score encoding;
iteratively training parameters of the deep neural network by minimizing the loss value to obtain a deep neural network model capable of encoding the real-time performance indicators of the server nodes into corresponding load score values; and
inputting the real-time performance indicators of the current server nodes into the trained deep neural network model to obtain the corresponding load score values.

7. The distributed task load balancing scheduling method according to claim 4, wherein said performing load balancing scheduling on tasks in the overloaded server nodes comprises:
detecting surrounding nodes of each overloaded server node in the server cluster network topology, and calculating a replacement matching degree between each surrounding node and each task to be offloaded; and
transferring, when the replacement matching degree between the surrounding node and the task to be offloaded is greater than a first preset threshold, the task to be offloaded to a corresponding surrounding node.

8. The distributed task load balancing scheduling method according to claim 7, wherein said calculating a replacement matching degree between each surrounding node and each task to be offloaded comprises:
calculating the replacement matching degree between each surrounding node and each task to be offloaded according to a replacement matching degree calculation formula, the replacement matching degree calculation formula being:
$$C = \frac{{R}_{i}}{{R}_{α i}} ln ( 1 + \frac{1}{{d}_{i} + 1} ) * exp ( \frac{{P}_{i} - {P}_{α}}{N} ) ,$$
where C is the replacement matching degree, Rᵢ is a node load value of an i-th surrounding node, R_{αi} is a corrected load threshold of the i-th surrounding node, dᵢ is a network distance value between the i-th surrounding node and the overloaded server node, Pᵢ is the matching degree between the node resource indicator radar chart of the i-th surrounding node and the performance requirement indicator radar chart of the task to be offloaded, P_{α} is a preset standard matching degree, and N is a range adjustment coefficient.

9. A distributed task load balancing scheduling system, comprising:
a task module configured to acquire performance requirement indicators of tasks to be executed, and allocate the tasks to be executed to server nodes in a server cluster network topology according to the performance requirement indicators of the tasks to be executed;
a threshold module configured to acquire historical load change rates of the server nodes, and determining a load threshold corresponding to each server node according to the historical load change rates of the server nodes; and
a scheduling module configured to acquire real-time performance indicators of the server nodes, determine load score values according to the real-time performance indicators of the server nodes, screen out overloaded server nodes whose load score values exceed the load thresholds, and performing load balancing scheduling on tasks in the overloaded server nodes;
wherein the task module allocating the tasks to be executed to server nodes in a server cluster network topology according to the performance requirement indicators of the tasks to be executed comprises:
acquiring the performance requirement indicators of each task to be executed, the performance requirement indicators including a CPU requirement indicator, an IO requirement indicator, a network requirement indicator, and a memory requirement indicator;
establishing a center of a circle, and taking the center of the circle as a starting point to evenly draw rays to the surroundings as indicator axes;
normalizing the performance requirement indicators of the task to be executed, and filling the normalized performance requirement indicators into the indicator axes; and
connecting the normalized performance requirement indicators on the indicator axes in sequence to obtain a performance requirement indicator radar chart of the task to be executed, and allocating the task to be executed to one server node according to the performance requirement indicator radar chart of the task to be executed.
